(19) United States
(12) Patent Application Publication
(10) Pub. No.: US 2018/0264989 A1
(43) Pub. Date: Sep. 20, 2018

(54) LOAD-SECUREMENT APPARATUS AND A METHOD OF INSTALLING THE LOAD-SECUREMENT APPARATUS TO SECURE A LOAD IN A SHIPPING CONTAINER

(71) Applicant: Signode Industrial Group LLC, Glenview, IL (US)

(72) Inventors: Dwight Linn Marshall, Charlotte, NC (US); Christopher Wayne Baker, Murfreesboro, TN (US)

(21) Appl. No.: 15/915,297

(22) Filed: Mar. 8, 2018

Related U.S. Application Data
(60) Provisional application No. 62/471,061, filed on Mar. 14, 2017.

(51) Int. Cl. B60P 7/08; B65D 90/00

(52) U.S. Cl. CPC B60P 7/0823; B65D 2590/0058; B65D 2590/005; B65D 90/0053

(57) ABSTRACT

The present disclosure provides a load-securement apparatus and a method of installing the load-securement apparatus to secure a load in a shipping container. In one embodiment, the load-securement apparatus includes a first non-rigid anchor member, a second non-rigid anchor member, a first non-rigid load restrainer, and a second non-rigid load restrainer. In one embodiment, the method of installing the load-securement apparatus comprises attaching the first load restrainer to the first anchor member, attaching the first anchor member to the shipping container adjacent a side wall, attaching the second load restrainer to the second anchor member, attaching the second anchor member to the shipping container adjacent another side wall, attaching the first load restrainer to the second load restrainer such that part of the first load restrainer and part of the second load restrainer both contact the load, and tensioning the attached first and second load restrainers to a designated tension.

### PRIORITY CLAIM

This application claims priority to and the benefit of U.S. Provisional Patent Application No. 62/471,061, filed Mar. 14, 2017, the entire contents of which are incorporated herein by reference.

### FIELD

The present disclosure relates to load-securement apparatuses, and more particularly to load-securement apparatuses for securing loads in shipping containers.

### BACKGROUND

Shipping companies use shipping containers to transport loads of goods over long distances via ship, rail, truck, or airplane. Shipping containers are large, usually metal boxes such as intermodal containers, rail cars, and over-the-road containers. To ship a load of goods using a shipping container, the goods are first loaded into the interior of the shipping container, typically until the shipping container reaches a maximum weight or maximum volume limit In many cases the goods don't completely fill the interior of the shipping container, which means voids exist within the load (i.e., between the goods themselves) and/or between the goods and the interior walls of the shipping container. If the voids aren't minimized or the load isn't secured against movement, the goods could shift during transit and collide with one another and the interior walls of the shipping container, damaging the goods (and the shipping container).

A need exists for new and improved apparatuses and methods for securing loads in shipping containers.

### SUMMARY

The present disclosure provides a load-securement apparatus and a method of installing the load-securement apparatus to secure a load in a shipping container.

In one embodiment, the load-securement apparatus includes a first non-rigid anchor member, a second non-rigid anchor member, a first non-rigid load restrainer, and a second non-rigid load restrainer. The first non-rigid anchor member is attachable to a shipping container adjacent one side wall of the shipping container. The first non-rigid load restrainer is slidably attachable to the first non-rigid anchor member. The second non-rigid anchor member is attachable to the shipping container adjacent an opposing side wall of the shipping container. The second non-rigid load restrainer is slidably attachable to the second non-rigid anchor member. The first and second non-rigid load restrainers are sized to wrap at least partially around an outwardly facing surface of a load in the shipping container and are fixedly attachable to one another to secure the load.

In one embodiment, the method of installing the load-securement apparatus comprises attaching the first load restrainer to the first anchor member, attaching the first anchor member to the shipping container adjacent one of its side walls, attaching the second load restrainer to the second anchor member, attaching the second anchor member to the shipping container adjacent another of its side walls, attaching the first load restrainer to the second load restrainer such that part of the first load restrainer and part of the second load restrainer both contact the load, and tensioning the attached first and second load restrainers together to a designated tension to form a unified barrier.

The tensioned load restrainers (forming the unified barrier) pull the load against a bulkhead wall of the shipping container with enough force to prevent the load from substantially moving longitudinally (i.e., from front to back or back to front); laterally (i.e., from side-to-side); or vertically (i.e., up and down) during transit, while also reducing voids between the goods and the walls of the shipping container. The act of tensioning these components also pulls the individual goods that comprise the load (e.g., drums, pallets, packages, and the like) together to reduce voids within the load.

Additional features and advantages are described in and will be apparent from the Detailed Description and the Figures.

### BRIEF DESCRIPTION OF THE DRAWINGS

FIG. 1A is a front-elevational view of the load restrainer of one embodiment of the load-securement apparatus of the present disclosure.

FIG. 1B is a back-elevational view of the load restrainer of FIG. 1A.

FIG. 1C is a fragmentary perspective view of the load restrainer of FIG. 1A that shows one of its loop portions.

FIG. 1D is a fragmentary perspective view of the load restrainer of FIG. 1A that shows one of its openings.

FIG. 2 is a fragmentary end-on view of a shipping container showing its empty interior.

FIG. 3 is a fragmentary end-on view of the shipping container of FIG. 2 showing its interior after a first anchor member of the load-securement apparatus has been threaded through a first attachment member of the shipping container.

FIG. 4 is a fragmentary end-on view of the shipping container of FIG. 2 showing its interior after the ends of the first anchor member have been threaded through the loop portions of a first load restrainer of the load-securement apparatus.

FIG. 5 is a fragmentary end-on view of the shipping container of FIG. 2 showing its interior after portions of the first anchor member near its ends have been attached to one another and tensioned to form a vertically extending loop.

FIG. 5A is a fragmentary perspective view of the anchor-member connector after the first anchor member has been tensioned to form a vertically extending loop.

FIG. 5B is a fragmentary perspective view of another embodiment of the anchor-member connector after the first anchor member has been tensioned to form a vertically extending loop.

FIG. 6 is a fragmentary end-on view of the shipping container of FIG. 2 showing its interior a second anchor member having a second load restrainer attached thereto has been attached to the shipping container.

FIG. 7 is a fragmentary end-on view of the shipping container of FIG. 2 showing its interior the first and second load restrainers have been moved into a loading configuration.

FIG. 8 is a fragmentary end-on view of the shipping container of FIG. 2 showing its interior a load has been loaded into the interior of the shipping container.

FIG. 9 is a fragmentary end-on view of the shipping container of FIG. 2 showing its interior the first and second load restrainers have been moved into a securing configuration.

FIG. 10 is a fragmentary end-on view of the shipping container of FIG. 2 showing its interior the first and second load restrainers have been attached to one another to secure the load.

FIG. 10A is a fragmentary perspective view of the load-restrainer connectors after the first and second load restrainers have been attached to one another.

FIG. 11 is a partial-cutaway-top-perspective view of the shipping container of FIG. 2 after the first and second load restrainers have been attached to one another to secure the load.

### DETAILED DESCRIPTION

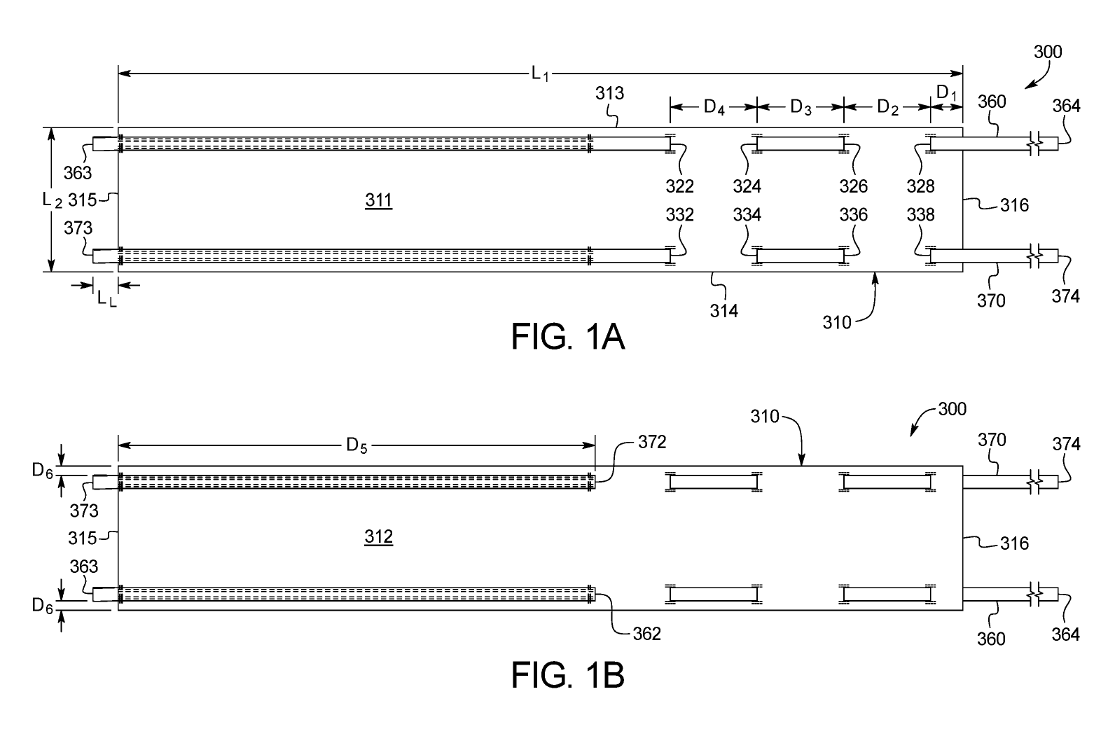

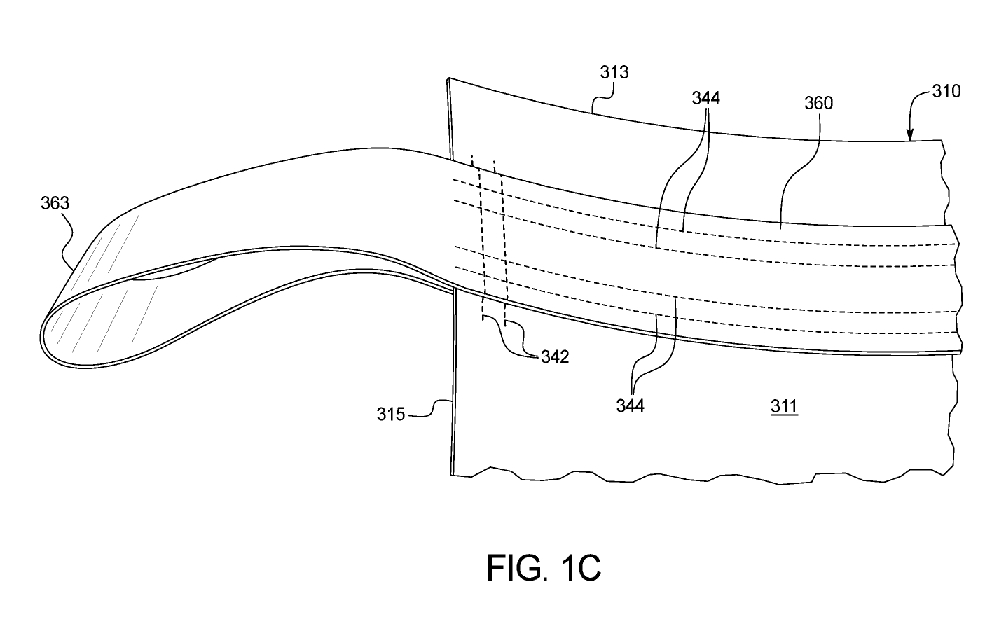

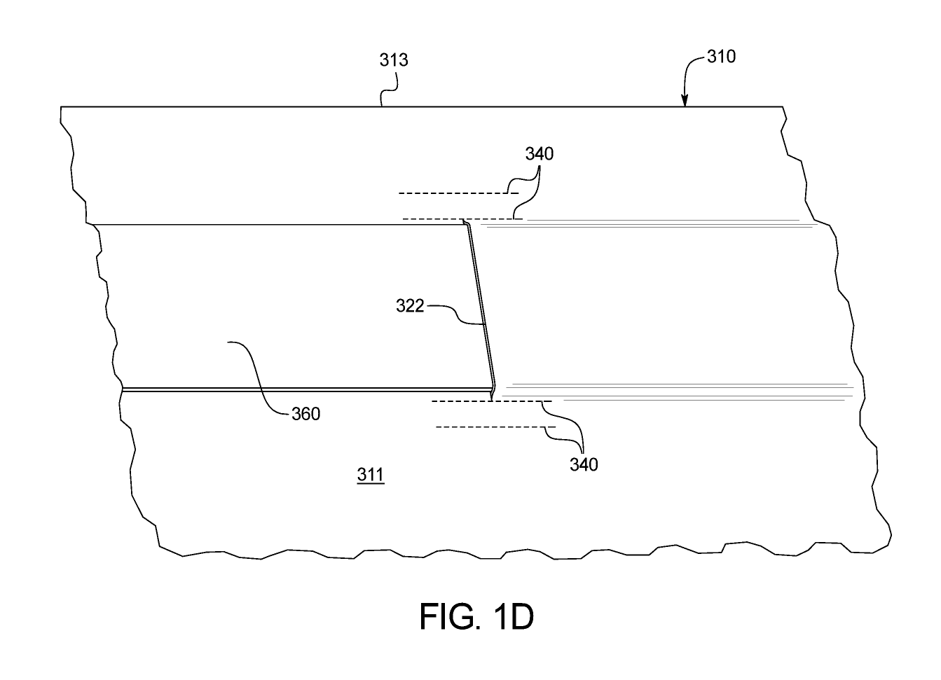

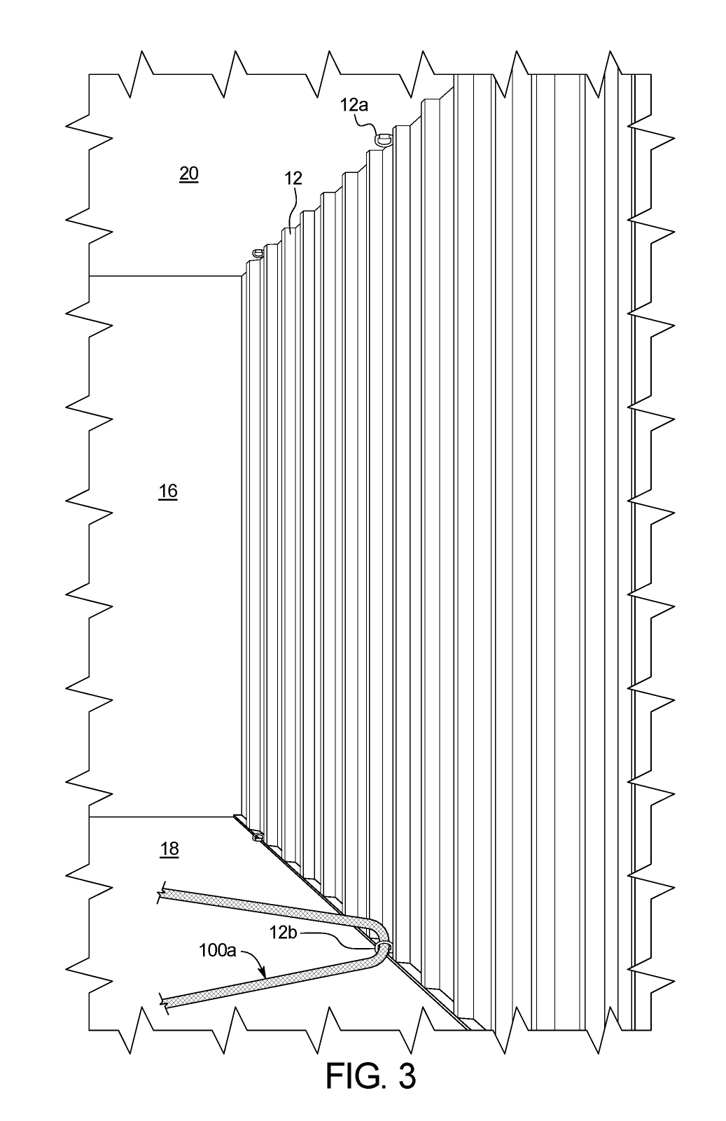

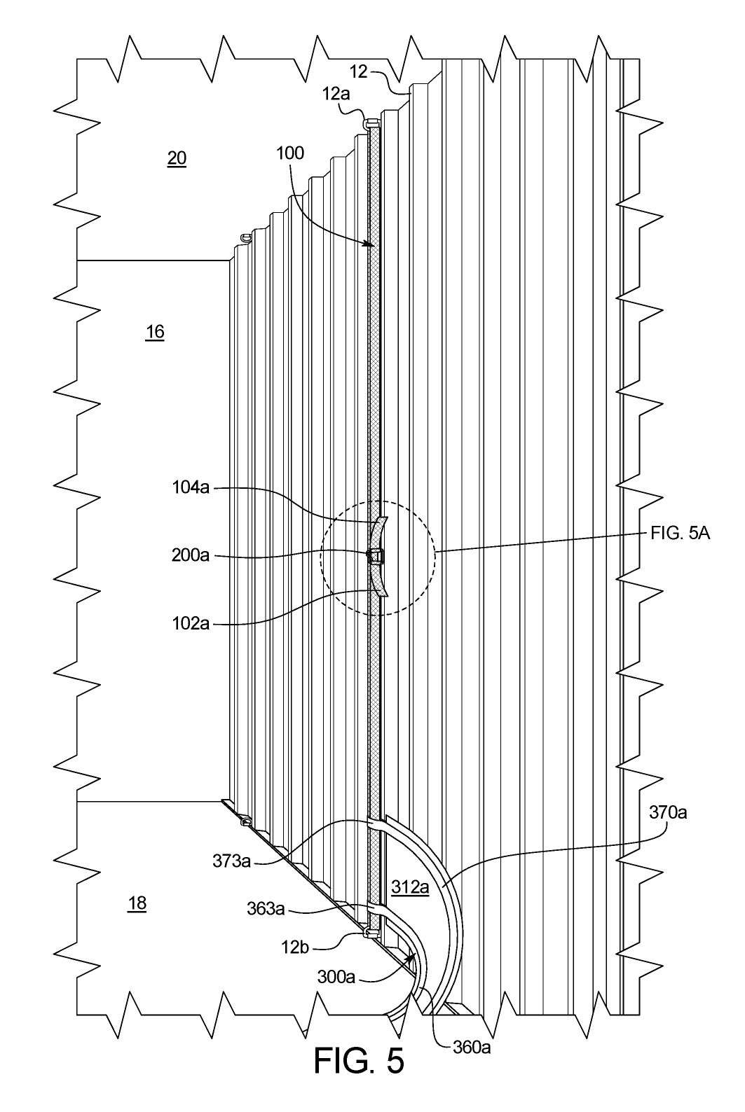

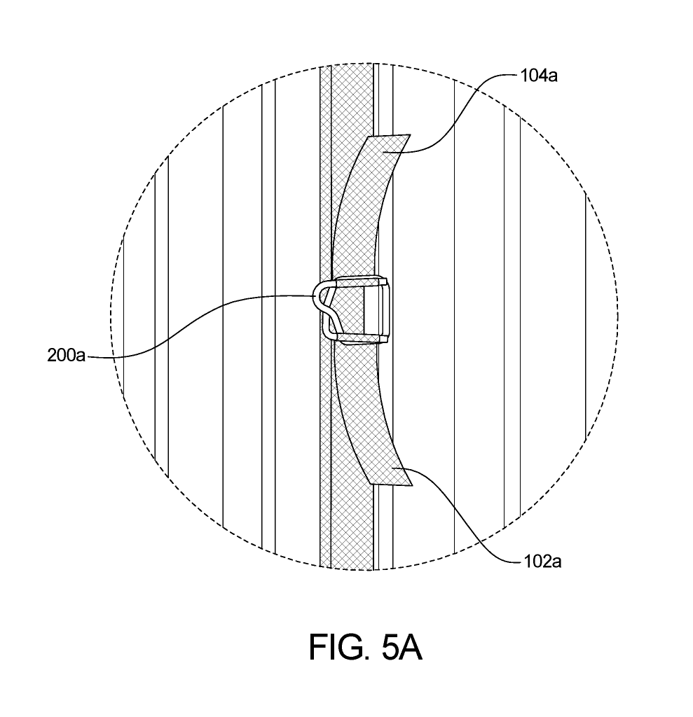

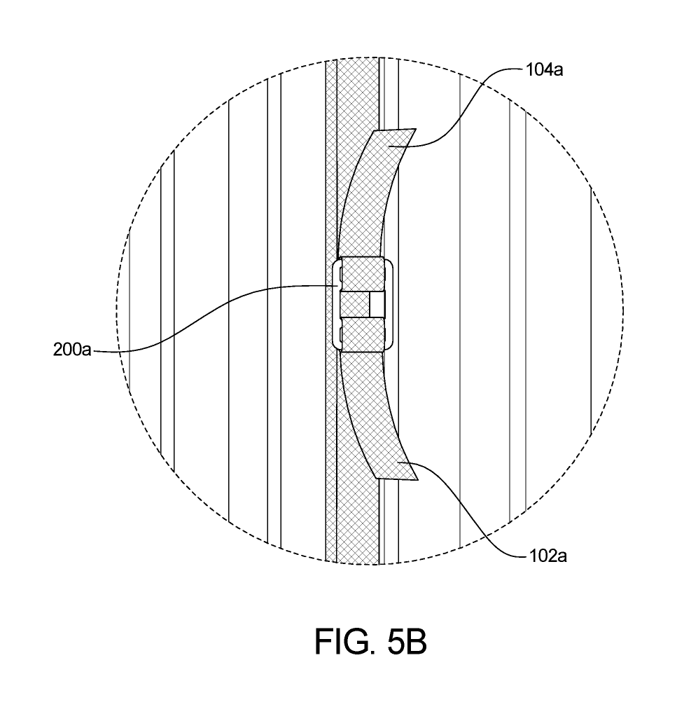

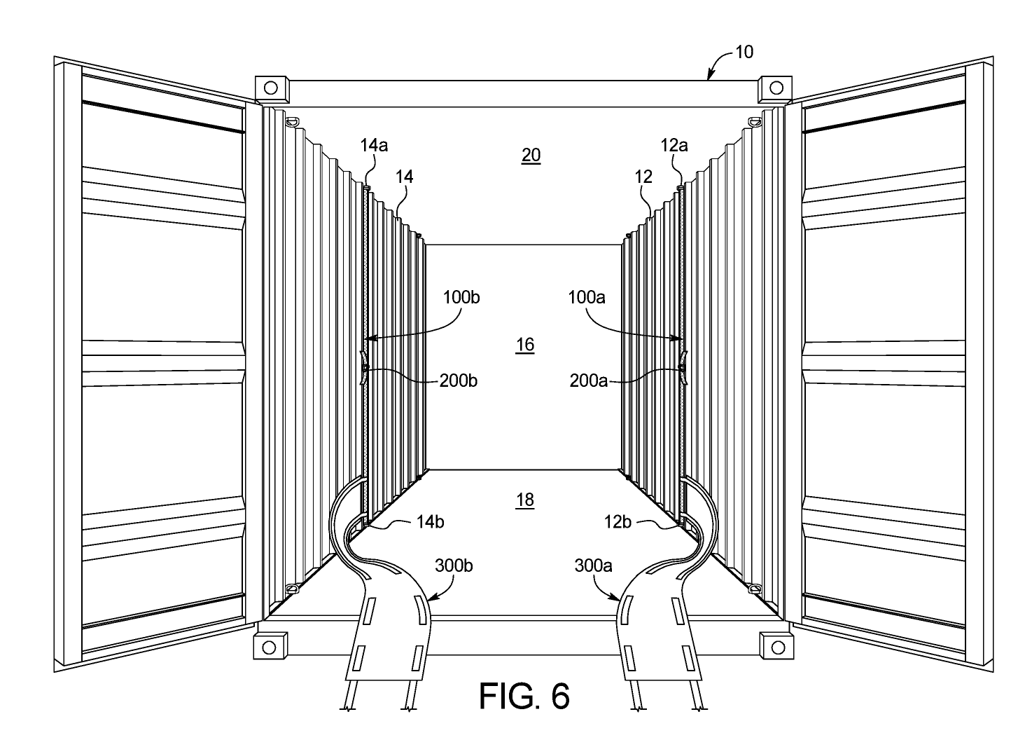

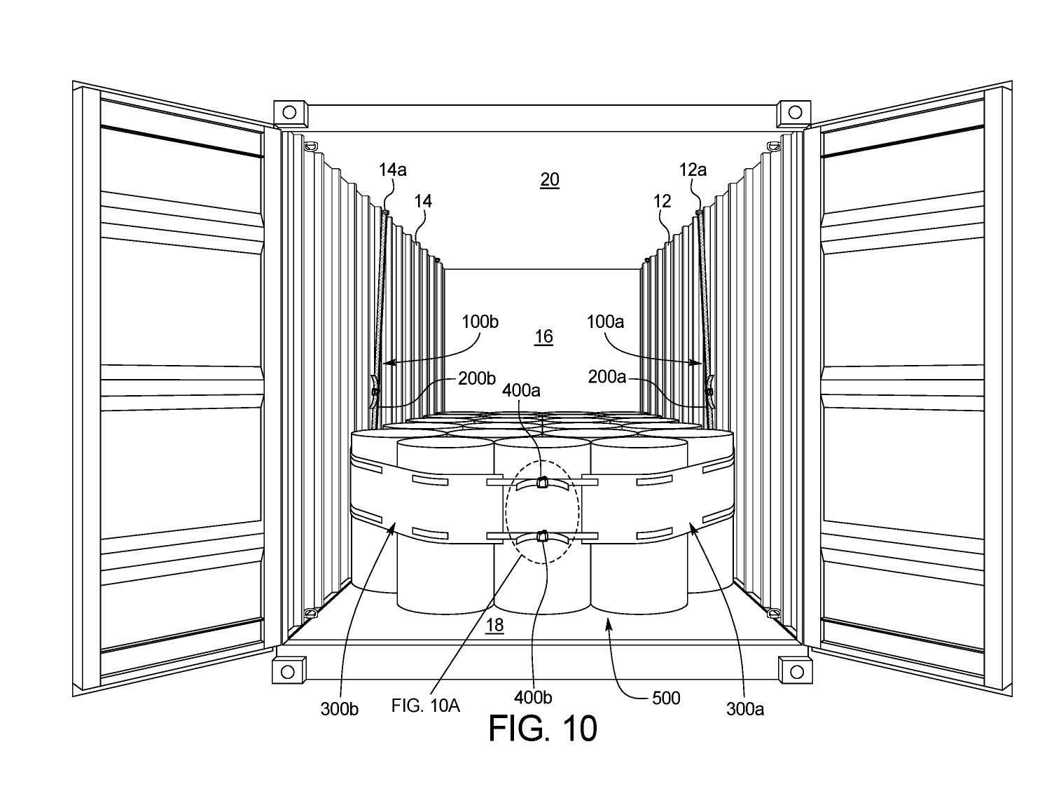

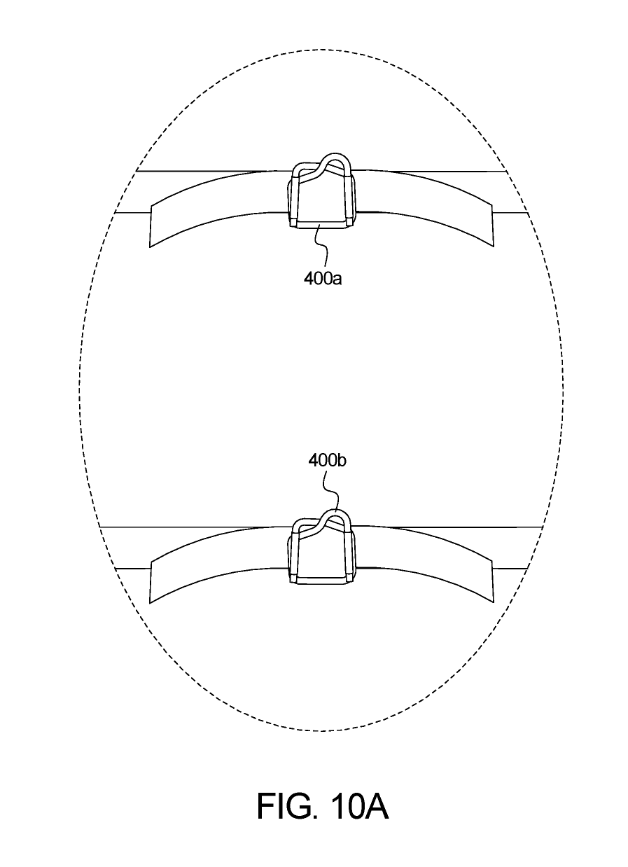

Various embodiments of the present disclosure provide a load-securement apparatus for securing a load within a container. FIGS. 1-11 illustrate one embodiment of the load-securement apparatus and its components. In this embodiment, the load-securement apparatus includes two identical non-rigid anchor members 100a and 100b (best shown in FIGS. 3-5A), two identical anchor-member connectors 200a and 200b (best shown in FIG. 5A), two identical load restrainers 300a and 300b (best shown in FIGS. 1A-1D), and two identical load-restrainer connectors 400a and 400b (best shown in FIG. 10A). The fact that the components are identical (or functionally identical) simplifies installation since the installer need not match particular components to particular sides of the shipping container. In other embodiments, the components aren't identical.

Since the anchor members 100a and 100b are identical (or functionally identical), when describing the elements, functions, and properties of the anchor members 100a and 100b the present disclosure sometimes refers to them as the anchor member 100 for clarity and brevity. Since the anchor-member connectors 200a and 200b are identical (or functionally identical), when describing the elements, functions, and properties of the anchor-member connectors 200a and 200b the present disclosure sometimes refers to them as the anchor-member connector 200 for clarity and brevity. Since the load restrainers 300a and 300b are identical (or functionally identical), when describing the elements, functions, and properties of the load restrainers 300a and 300b the present disclosure sometimes refers to them as the load restrainer 300 for clarity and brevity. Since the load-restrainer connectors 400a and 400b are identical (or functionally identical), when describing the elements, functions, and properties of the load-restrainer connectors 400a and 400b the present disclosure sometimes refers to them as the load-restrainer connector 400 for clarity and brevity.

As best shown in FIGS. 3-5A, in this illustrated embodiment the non-rigid anchor member 100 includes a rectangular, 210 inch long, 1.5 inch wide woven polyester strap having adherence to American Society for Testing and Materials (ASTM) Grade 5 nonmetallic strapping with a minimum straight break strength of 5,400 pounds and ASTM Grade 4 nonmetallic strapping with minimum straight break strength of 3,800 pounds. The length, width, and material of the anchor member may differ so long as the anchor member has a break strength of no less than 3,800 pounds. In other embodiments, the anchor member could be made of a bonded composite, a natural or cotton fiber, nylon, or another polymer-based material. In other embodiments, the non-rigid anchor member includes something other than a strap, such as (but not limited to) a rope, a chain, a cord, a wire, or a cable. The non-rigid anchor member 100 has a first end 102 and a second end 104.

As best shown in FIG. 5A, in this illustrated embodiment the anchor-member connector 200 includes a bent-wire metal buckle for polyester strapping, such as a Model No. ST-32WB Extra Grip 32 mm Bent Wire Metal Buckle available from Allegheny Industrial Associates. In other embodiments, the anchor-member connector includes something other than a known metal polyester strapping buckle, such as (but not limited to) a ladder buckle such as a Model No. ST-421b 42 mm forged ladder buckle for polyester strapping available from Allegheny Industrial Associates, a ratchet-style connector, an endless-cam-style connector, or a retention clip.

As best shown in FIGS. 1A-1D, the load securer 300 includes a non-rigid barrier 310 and first and second non-rigid load-restraining members 360 and 370 attached to the barrier 310.

The barrier 310 has an outwardly facing surface 311 and a load-contacting surface 312. The barrier 310 is rectangular and has spaced-apart opposing first and second sides 313 and 314 and spaced-apart opposing first and second ends 315 and 316. In this illustrated embodiment, the first and second sides 313 and 314 each have a length L₁, which is 100 inches in this example embodiment, and the first and second ends 315 and 316 each have a length L₂, which is 18 inches in this example embodiment. The sides and ends may be any suitable lengths, and the barrier may take any other suitable shape.

A first set of longitudinally aligned load-restraining member receiving openings (here, slits) 322, 324, 326, and 328 are defined through the barrier 310 near the first side 313, and a second set of longitudinally aligned load-restraining member receiving openings (here, slits) 332, 334, 336, and 338 are defined through the barrier 310 near the second side 314. In this example embodiment, each load-restraining member receiving opening extends parallel to the first and second ends 315 and 316 and transverse (here, perpendicular) to the first and second sides 313 and 314.

Each load-restraining member receiving opening has a height H_{OPENING}, which is 1.75 inches in this embodiment. The height H_{OPENING} may be any suitable height that is larger than the width of the load-restraining member that passes through the load-restraining member receiving opening (described below). The load-restraining member receiving opening 328 and the second end 316 are spaced apart by a distance D₁, which is 6 inches in this example embodiment (though it may be any other suitable value in other embodiments). The load-restraining member receiving opening 338 and the second end 316 are also spaced apart by the distance D₁ (though it may be a different distance in other embodiments). The load-restraining member receiving opening 328 and the load-restraining member receiving opening 326 are spaced apart by a distance D₂, which is 16 inches in this example embodiment (though it may be any other suitable value in other embodiments). The load-restraining member receiving opening 338 and the load-restraining member receiving opening 336 are also spaced apart by the distance D₂ (though it may be a different distance in other embodiments). The load-restraining member receiving opening 326 and the load-restraining member receiving opening 324 are spaced apart by a distance D₃, which is 10 inches in this example embodiment (though it may be any other suitable value in other embodiments). The load-restraining member receiving opening 336 and the load-restraining member receiving opening 334 are also spaced apart by the distance D₃ (though it may be a different distance in other embodiments). The load-restraining member receiving opening 324 and the load-restraining member receiving opening 322 are spaced apart by a distance D₄, which is 10 inches in this example embodiment (though it may be any other suitable value in other embodiments). The load-restraining member receiving opening 334 and the load-restraining member receiving opening 332 are also spaced apart by the distance D₄ (though it may be a different distance in other embodiments). The barrier may define any suitable quantity of load-restraining member receiving openings that take any suitable shape.

The barrier 310 includes a pair of spaced-apart parallel rows of reinforcing stitching 340 just above and just below each load-restraining member receiving opening. The reinforcing stitching 340 extends through the barrier 310. The reinforcing stitching 340 is transverse (here, perpendicular) to the load-restraining member receiving openings and strengthens the barrier 310 by reducing the likelihood that the barrier 310 will tear near the load-restraining member receiving openings when in use. In other embodiments, the barrier includes only one row of reinforcing stitching per upper and lower end of each load-restraining member receiving opening rather than a pair of rows of reinforcing stitching per upper and lower end as shown. In other embodiments, the reinforcing stitching doesn't comprise laterally spaced-apart rows of stitching, but continuous rows. In other embodiments, the barrier includes reinforcing stitching that extends around the perimeter of each opening. In other embodiments, the barrier includes something other than stitching to reinforce the openings, such as additional material above, below, or around each opening.

In this example embodiment, the barrier 310 is made of woven polypropylene. The material of the barrier may differ, and may include woven polyethylene, spun-bond polyolefins, and/or extruded plastic film like polyethylene. In certain embodiments, the length L₁ of the barrier is 30 inches to 144 inches and the length L₂ of the barrier is 8 inches to 48 inches.

The load-restraining members 360 and 370 include rectangular, 216 inch long, 1.5 inch wide woven polyester straps having equivalency to ASTM Grade 5 nonmetallic strapping with a minimum straight break strength of 5,400 pounds and ASTM Grade 4 nonmetallic strapping with minimum straight break strength of 3,800 pounds. The length, width, and material of the load-restraining members may differ so long as the load-restraining members each have a break strength no less than 3,800 pounds. In other embodiments, the load-restraining member could be made of a bonded composite, a natural or cotton fiber, nylon, or another polymer-based material. In other embodiments, the load-restraining member includes something other than a strap, such as (but not limited to) a rope, a chain, a cord, a wire, or a cable.

As best shown in FIGS. 1A-1D, the load-restraining member 360 is attached to the barrier 310 such that: (1) a first attached portion of the load-restraining member 360 extends for a distance D₅ along the load-contacting surface 312 of the barrier 310 parallel to and offset a distance D₆ from the first side 313 and terminates in an attached end 362; (2) a second attached portion of the load-restraining member 360 extends along the outwardly facing surface 311 of the barrier 310 parallel to and offset the distance D₆ from (though it may be a different distance in other embodiments) the first side 313 for the distance D₅ (though it may be a different distance in other embodiments); (3) a third loop portion 363 is formed adjacent the first end 315 and has a length L_{L} when flattened; and (4) a free portion extends from the second attached portion, passes through the load-restraining member receiving openings 322, 324, 326, and 328 in a serpentine manner, and terminates in a free end 364. The distance D₅ is 44 inches in this illustrated embodiment but may be any suitable distance. The distance D₆ is 1 inch in this illustrated embodiment but may be any suitable distance. The length L_{L} is 4 inches in this illustrated embodiment but may be any suitable length.

The first and second attached portions of the load-restraining member 360 are attached to one another (and to the barrier 310) via: (1) transverse stitching 342 near the attached end 362 and near the first end 315 that passes from the first attached portion through the barrier 310 to the second attached portion; and (2) longitudinal stitching 344 (here, a quadruple stitch) extending along the length of the attached portions for the distance D₅ and that passes from the first attached portion through the barrier 310 to the second attached portion. In other embodiments, the load restrainer may have more or less stitching. In other embodiments, the first load-restraining member is attached to the barrier using other manners of attachment, such as adhesive, hook-and-loop fasteners, stapling, or sonic or other suitable welding.

As also best shown in FIGS. 1A-1D, the load-restraining member 370 is attached to the barrier 310 such that: (1) a first attached portion of the load-restraining member 370 extends for the distance D₅ (though it may be a different distance in other embodiments) along the load-contacting surface 312 of the barrier 310 parallel to and offset the distance D₆ (though it may be a different distance in other embodiments) from the second side 314 and terminates in an attached end 372; (2) a second attached portion of the load-restraining member 370 extends along the outwardly facing surface 311 of the barrier 310 parallel to and offset the distance D₆ from (though it may be a different distance in other embodiments) the second side 314 for the distance D₅ (though it may be a different distance in other embodiments); (3) a third loop portion 373 is formed adjacent the first end 315 and has the length L_{L} when flattened (though it may be a different distance in other embodiments); and (4) a free portion extends from the second attached portion, passes through the load-restraining member receiving openings 332, 334, 336, and 338 in a serpentine manner, and terminates in a free end 374.

The first and second attached portions of the load-restraining member 370 are attached to one another (and to the barrier 310) via: (1) transverse stitching 342 near the attached end 362 and near the first end 315 that passes from the first attached portion through the barrier 310 to the second attached portion; and (2) longitudinal stitching 344 (here, a quadruple stitch) extending along the length of the attached portions for the distance D₅ and that passes from the first attached portion through the barrier 310 to the second attached portion. In other embodiments, the load restrainer may have more or less stitching. In other embodiments, the first load-restraining member is attached to the barrier using other manners of attachment, such as such as adhesive, hook-and-loop fasteners, stapling, or sonic or other suitable welding.

As best shown in FIGS. 1A and 1B, the first and second attached portions of the first and second load-restraining members 360 and 370 are parallel to one another.

As best shown in FIG. 10, in this illustrated embodiment the load-restrainer connector 400 includes a bent-wire metal buckle for polyester strapping, such as the one described above. In other embodiments, the load-restrainer connector includes something other than a known metal polyester strapping buckle, such as (but not limited to) a ladder buckle, a ratchet-style connector, an endless-cam-style connector, or a retention clip. The load-restrainer connector may be the same as or different from the anchor-member connector.

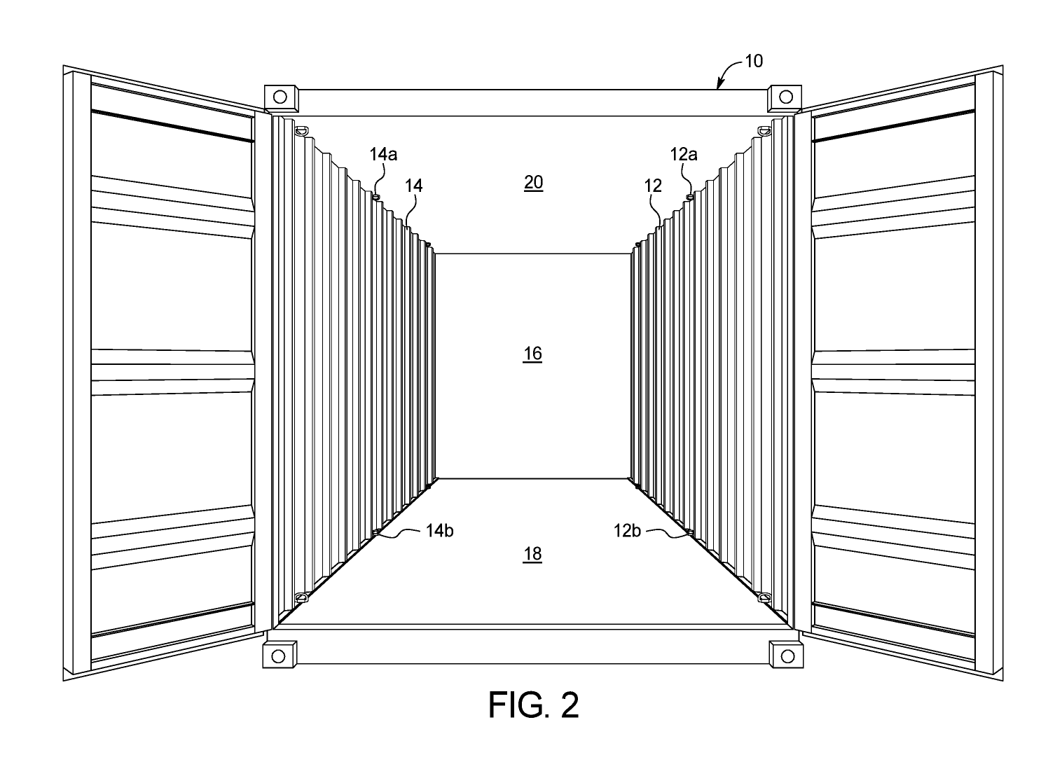

FIGS. 2-11 show one example method of installing the load-securement apparatus in a shipping container 10 to secure a load in the shipping container 10.

As best shown in FIG. 2, the shipping container 10 includes a corrugated first side wall 12, an opposing corrugated second side wall 14, a bulkhead wall 16, a floor 18, a corrugated ceiling 20, and two doors (not labeled) opposite the bulkhead wall 16. This is one example shipping container, and the load-securement apparatus can be installed in any other suitable shipping container, including a high-cube style container or any other similarly equipped transport trailer.

A first upper attachment member 12a, which includes a d-ring in this embodiment, is attached to the ceiling 20 near where it connects to the first side wall 12, and a first lower attachment member 12b, which includes a d-ring g in this embodiment, is attached to the floor 18 near where it connects to the first side wall 12. The first upper and lower d-rings 12a and 12b are spaced the same distance from the bulkhead wall 16 such that a line connecting the first upper and lower d-rings 12a and 12b is parallel to the first and second side walls 12 and 14 and perpendicular to the floor 18 and the ceiling 20. Similarly, a second upper attachment member 14a, which includes a d-ring in this embodiment, is attached to the ceiling 20 near where it connects to the second side wall 14, and a second lower attachment member 14b, which includes a d-ring g in this embodiment, is attached to the floor 18 near where it connects to the second side wall 14. The second upper and lower d-rings 14a and 14b are spaced the same distance from the bulkhead wall 16 such that a line connecting the second upper and lower B-rings 14a and 14b is parallel to the first and second side walls 12 and 14 and perpendicular to the floor 18 and the ceiling 20. The first upper and lower d-rings 12a and 12b and the second upper and lower d-rings 14a and 14b are spaced the same distance from the bulkhead wall 16 such that a plane including the line connecting the first upper and lower d-rings 12a and 12b and the line connecting the second upper and lower d-rings 14a and 14b is parallel to the bulkhead wall 16 and perpendicular to the first and second side walls 12 and 14, the floor 18, and the ceiling 20. In other embodiments, the anchor members are attached to the side walls of the shipping container and/or to the corners of the shipping container rather than the floor and ceiling (or a combination thereof).

Certain shipping containers—such as the shipping container 10—include integrated attachment members (like d-rings) spaced apart at regular intervals along the length of the shipping container. In these instances, the load-securement apparatus of the present disclosure leverages prebuilt attachment points for its anchor members to speed installation and reduce the number of components. In instances in which shipping containers don't include integrated attachment members, the load-securement apparatus may include attachment members and the method of installing the load-securement apparatus may include attaching the attachment members to the shipping container to provide attachment points for the anchor members.

To install the load-securement apparatus, the installer first threads the first anchor member 100a through the first lower d-ring g 12b so the midpoint of the first anchor member 100a is positioned at the first lower d-ring 12b. At this point, as shown in FIG. 3, the ends 102a and 104a of the first anchor member 100a lie on the floor 18 of the shipping container 10.

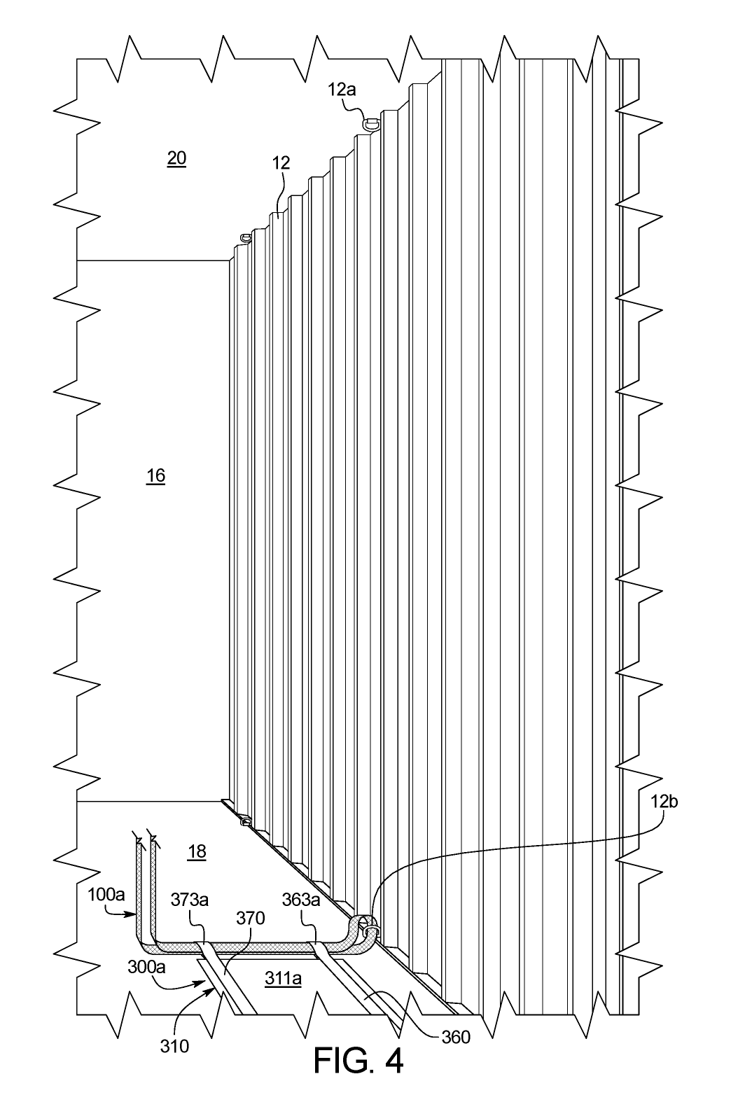

The installer then attaches the first load restrainer 300a to the first anchor member 100a by threading the first and second ends 102a and 104a of the first anchor member 100a through the loop portion 363a of the first load-restraining member 360a of the first load restrainer 300a and then through the loop portion 373a of the second load-restraining member 370a of the first load restrainer 300a, as shown in FIG. 4.

The installer then threads the second end 104a of the first anchor member 100a through the first upper d-ring g 12a and attaches portions of the first anchor member 100a near its first and second ends 102a and 104a to one another using the anchor-member connector 200a (as is known in the art) to form the first anchor member 100a into a vertically extending loop (that extends through the loop portions of the load-restrainer). The installer uses a known strap-tensioning device (not shown) to tension the first anchor member 100a to a first designated tension, which is 400 pounds of manual or automatic draw strength in this example embodiment, but could be any tension, such as a tension between 300 and 900 pounds of manual or automatic draw strength. This tensioning permanently deforms the anchor-member connector 200a to permanently affix the first anchor member 100a to itself to form the loop. In other embodiments, a temporary connection may be made that may not require permanent deformation of the anchor connector. FIG. 5 shows the tensioned vertically extending loop that the anchor member 100a forms. The looped anchor member 100a extends adjacent the first side wall 12. FIG. 5A shows the anchor-member connector 200a. FIG. 5B shows an alternative anchor-member connector in the form of a ladder buckle. The strap-tensioning device may be any suitable strap-tensioning device, such as a manual windlass, pneumatic, or automatic tool. At this point, the load restrainer 300a is movable along and relative to the first anchor member 100a.

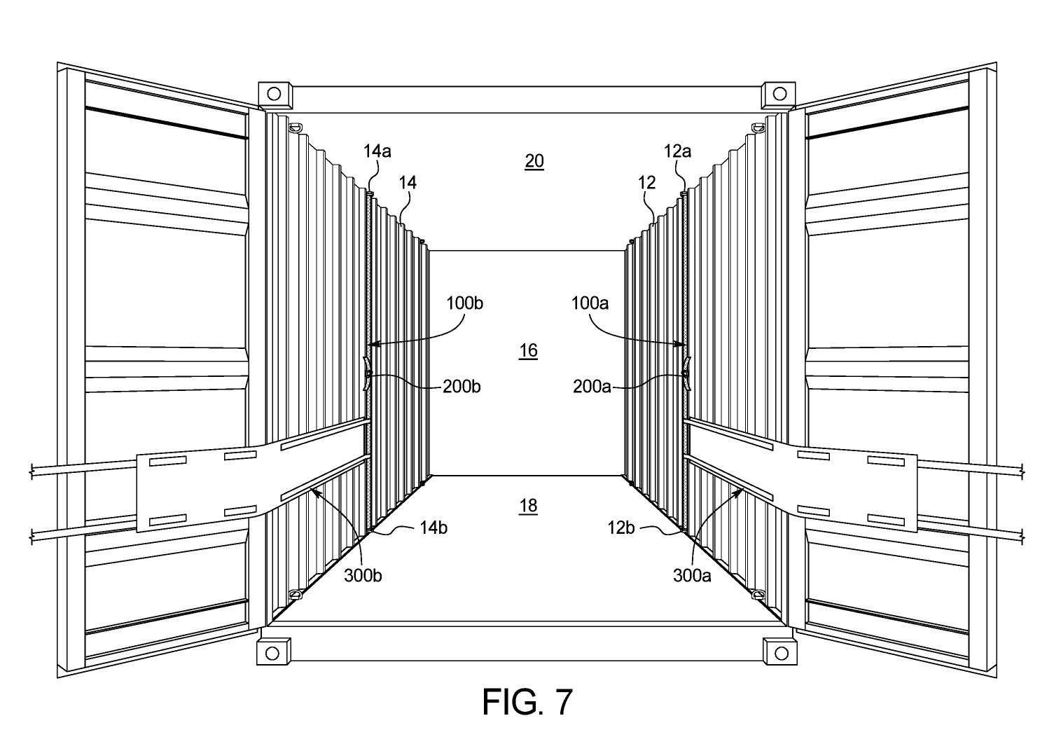

The installer repeats this process for the second anchor member 100b, the second anchor-member connector 200b, and the second load restrainer 300b. One difference is that the installer attaches the second load restrainer 300b to the second anchor member 100b by first threading the ends 102b and 104b through the loop portion 373b of the second load-restraining member 360b of the second load restrainer 300b and then through the loop portion 363b of the first load-restraining member 360b of the second load restrainer 300b. This ensures the load-contacting surface 312b of the barrier 310b contacts the load (as described below). FIG. 6 shows the installed second anchor member 100b, second anchor-member connector 200b, and second load restrainer 300b. In other embodiments, the second load restrainer 300b can be installed in the same manner as the first load restrainer 300a without adversely affecting performance. That is, the first and second load restrainers are reversible and interchangeable. The looped anchor member 100b extends adjacent the second side wall 14.

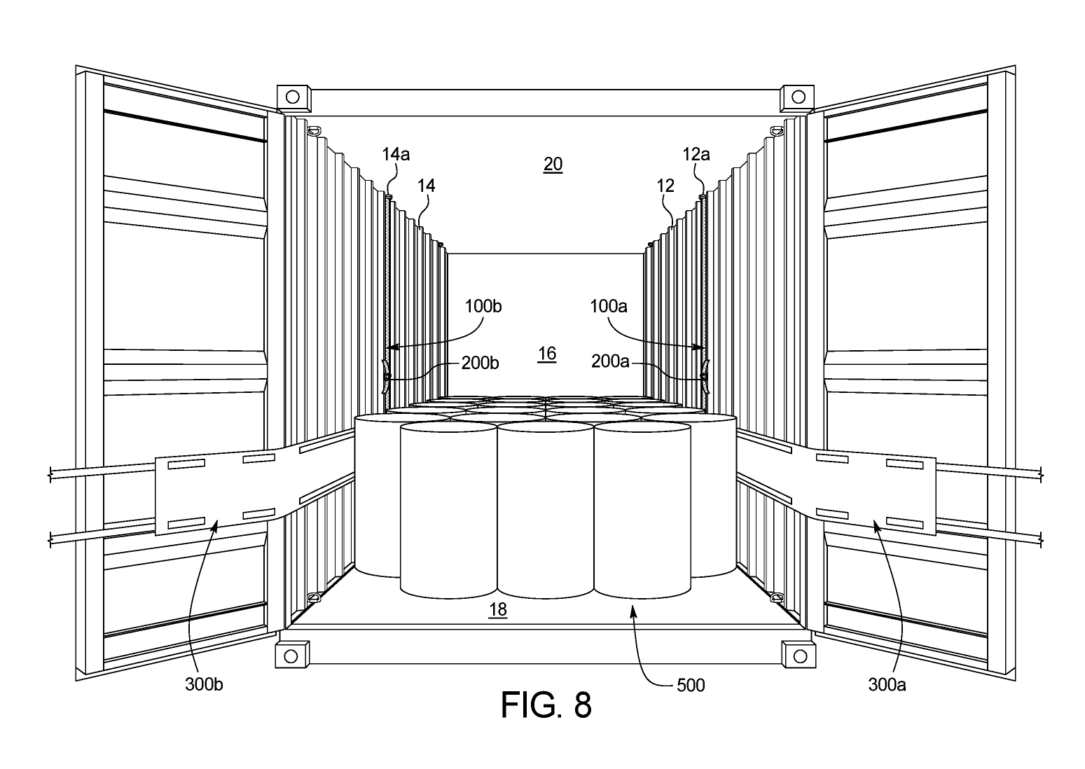

To prepare the shipping container for loading, the installer moves the first and second load restrainers 300a and 300b into a loading configuration in which they extend parallel to the respective side walls 12 and 14 and in which their free ends extend out of the shipping container. FIG. 7 shows the load restrainers in the loading configuration. With the first and second load restrainers 300a and 300b out of the way, the installer can load the shipping container 10 using a forklift, hand truck, or other implement. FIG. 8 shows a load 500—drums in this illustrated embodiment—in the shipping container 10. Any suitable goods, palletized or not, may be loaded into the shipping container. In certain embodiments, the load-securement system includes multiple sidewall connectors configured to removably attach the barriers to the shipping container to keep them out of the way while goods are loaded. The sidewall connectors may include magnets, adhesive, or hooks or other suitable fasteners.

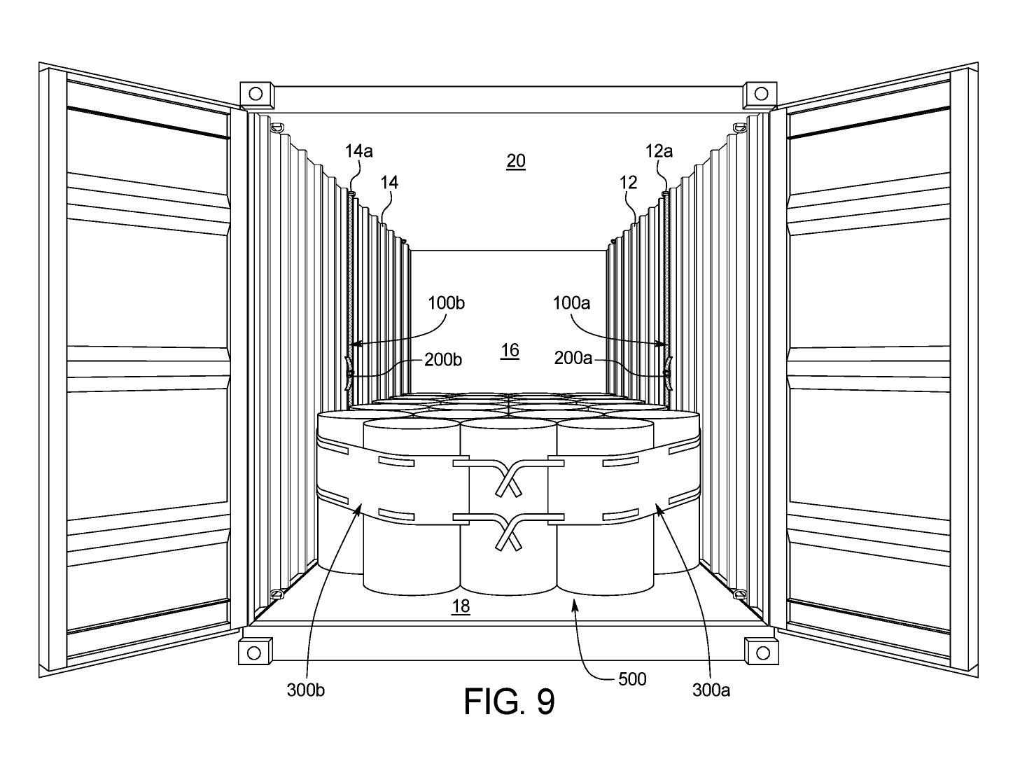

After loading the shipping container 10, the installer moves the first and second load restrainers 300a and 300b into a securing configuration in which the load-contacting surfaces 312 of the of the first and second load restrainers 300a and 300b contact the outer face of the load 500 and the second ends 316a and 316b of the first and second load restrainers 300a and 300b are positioned adjacent (but spaced apart from) one another about midway between the first and second side walls 12 and 14. The serpentine threading of the load-restraining members through the barriers enables the installer to, if needed, push excess barrier fabric away from the midpoint between the first and second side walls 12 and 14 to ensure the barriers don't interfere with tensioning (as described below). This enables the load-securement system to be used with many different load sizes and configurations, as the barrier is freely retractable (and extendable) along its length where not fixedly attached to the load-restraining members. FIG. 9 shows the load restrainers 300 in the securing configuration. At this point, the installer can move the first and/or the second load restrainer 300a and 300b vertically relative to the respective anchor member 100a and/or 100b if desired to properly position the load restrainer(s).

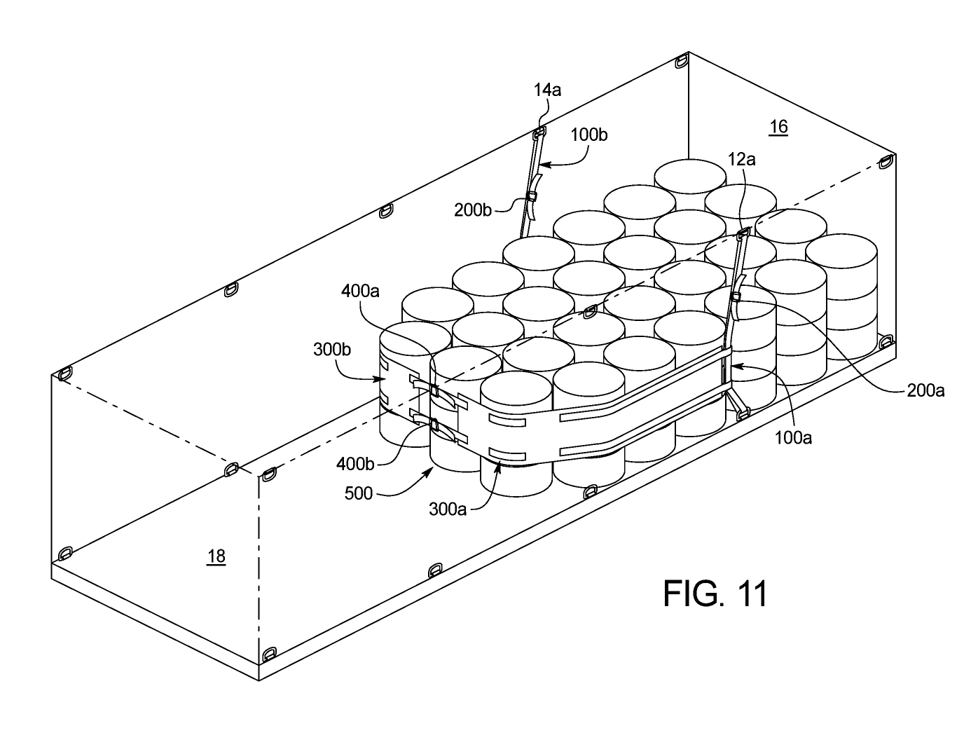

The installer then attaches the second load-restraining member 374a of the first load restrainer 300a to the first load-restraining member 364b of the second load restrainer 300b using the first load-restrainer connector 400a (as is known in the art). The installer uses the strap tensioning device (not shown) to tension the load-restraining members 374a and 364b to a second designated tension, which is 400 pounds of manual or automatic draw strength in this example embodiment, but could be any tension between 300 and 900 pounds of manual or automatic draw strength. The installer also attaches the first load-restraining member 364a of the first load restrainer 300a to the second load-restraining member 374b of the second load restrainer 300b using the second load-restrainer connector 400b (as is known in the art). The installer uses the strap tensioning device (not shown) to tension the load-restraining members 364a and 374b to the second designated tension. This tensioning permanently deforms the load-restrainer connector 400a to permanently affix the second load-restraining member 374a of the first load restrainer 300a to the first load-restraining member 364b of the second load restrainer 300b. In other embodiments, a temporary connection may be made that may not require permanent deformation of the anchor connector. This tensioning also permanently deforms the load-restrainer connector 400b to permanently affix the first load-restraining member 364a of the first load restrainer 300a to the second load-restraining member 374b of the second load restrainer 300b. In other embodiments, a temporary connection may be made that may not require permanent deformation of the anchor connector. FIGS. 10, 10A, and 11 show the attached and tensioned load restrainers. FIG. 10A shows the load-restrainer connectors 400a and 400b. As best shown in FIG. 11, the first and second anchor members 100 form the shape of a bow after the load restrainers 300 are tensioned.

Once the load-securement system is tensioned, the load restrainers 300 extend transverse to (here, perpendicular to) the anchor members 100 and generally parallel to the floor 10 of the shipping container 10. The tensioned load restrainers 300 pull the load 500 against the bulkhead wall 16 of the shipping container 10 with enough force to prevent the load 500 from substantially moving longitudinally (i.e., from front to back or back to front); laterally (i.e., from side-to-side); or vertically (i.e., up and down) during transit while also reducing voids between the goods and the walls of the shipping container. The act of tensioning these components also pulls the individual goods that comprise the load (e.g., drums, pallets, packages, and the like) together to reduce voids within the load. After tensioning, vertical movement of the load restrainers 300 is severely restricted due to the tensioning force, and movement of the anchor members 100 and load-restraining members 360 and 370 is limited.

Installing this example load-securement system requires permanently deforming the anchor and load-restrainer connectors. Accordingly, to remove the load-securement system and unload the shipping container, the unloader severs the anchor members and the load-restraining members. In other embodiments using different connectors, this cutting may not be necessary.

The load-securement apparatus and method of installation are beneficial for a variety of reasons, some of which are listed below in no particular order.

The load-securement-apparatus installer doesn't need to precisely position the anchor members relative to the bulkhead wall of the shipping container. Instead, the method of installing the load-securement apparatus leverages the attachment members (e.g., d-rings) already permanently integrated into standard shipping containers as attachment points for the anchor members. This not only eliminates the measurement step to speed installation but also reduces the likelihood of attaching an anchor member in the wrong place an action that would lengthen installation and that could weaken load securement.

The location of the attachment members enables the load-securement apparatus to secure heavy loads and withstand high forces. The upper and lower corners and edges of the shipping container are some of its strongest points and are typically reinforced.

The load-securement-apparatus installer also doesn't need to precisely position the load restrainers relative to the floor of the shipping container before loading the shipping container. Instead, the load restrainers are slidably attached to the anchor members to enable the installer to vertically move them after loading to accommodate the size and shape of that particular load. This enables one method of installation to suffice for any of a number of different load configurations.

Further, the load-securement apparatus installer doesn't need to learn new techniques for attaching and tensioning straps, as the method of installing the load-securement apparatus leverages installers' existing knowledge base by using standard strap buckles and tensioning devices. This results in faster installation, fewer errors, and a less steep learning curve that enables installers to quickly get up to speed and become proficient in installing the load-securement apparatus.

The load-securement apparatus doesn't contaminate or damage the shipping container. The load-securement apparatus attaches to the shipping container through four existing attachment members in the shipping container. To remove the load-securement apparatus an unloader cuts the anchor and load-restraining members, pulls the materials out of the shipping container, and recycles them or throws them away. The load-securement apparatus doesn't leave any residue on or in the shipping container or damage the floor or any other component of the shipping container.

The load-securement apparatus of the present disclosure can be used to secure any of multiple different types of loads, such as those including drums, barrels, bags, bulk containers, stone, or ceramics.

In certain instances, such as when a shipping container is to be nearly entirely filled with a load, multiple load-securement apparatuses may be used to secure different portions of that load. For instance, a first load-securement apparatus attached to the shipping container via attachment members near the shipping container's bulkhead wall is used to secure the first half of the load and a second load-securement apparatus attached to the shipping container via attachment members near its longitudinal midpoint is used to secure the second half of the load.

In certain instances, a load may fill the shipping container from floor to ceiling. In these instances, multiple sets of first and second load restrainers may be used to secure the load. In one embodiment, both first load restrainers are attached to the same first anchor member and both second load restrainers are attached to the same second anchor member. For instance, if another layer of drums was stacked atop the layer shown in FIGS. 8-11 above, another set of first and second load restrainers would be respectively attached to the anchor members 100a and 100b to secure that top layer of barrels. In another embodiment, the first load restrainers are attached to different first anchor members (both of which are attached to the same set of upper and lower attachment members) and the second load restrainers are attached to different second anchor members (both of which are attached to the same set of upper and lower attachment members).

In another embodiment, the barrier does not define any load-restraining member receiving openings, and the load-restraining members are attached (such as via stitching or any other suitable manner of attachment) to the barrier along their entire lengths. In certain embodiments, the barrier is not attached to the load-restraining members, and is positioned between the load-restraining members and the load during installation.

In another embodiment, the load restrainer does not include a barrier. Rather, in this embodiment, the load restrainer includes the two spaced apart load-restraining members and multiple non-rigid vertical members (such as straps) spanning the load-restraining members to create a ladder shape. In this embodiment, each vertical member forms loops at its ends, and the opposing load-restraining members are threaded through the respective loops. The loops enable the vertical member to be moved relative to the load-restraining members. In one embodiment, a certain quantity of the vertical members (such as three or four adjacent the free ends of the load-restraining members) are affixed by an easily removable stitch that enables the installer to remove them if desired (e.g., if securing a relatively small load).

In other embodiments, the load restrainers include elements other than loops formed by the load-restraining members that enable the load restrainers to attach to the anchor members. In some embodiments, the load restrainers include one or more carabiners, hooks, A-clips, or E-clips that enable the load restrainers to be attached to the anchor members even after the anchor members have been looped and tensioned. For instance, for a given load restrainer, a first carabiner is attached to the first load-restraining member and a second carabiner is attached to the second load-restraining member. The first and second carabiners are attachable to the anchor member. In some of these embodiments, the anchor members and/or the load restrainers are reusable, as in certain instances they need not be cut to disassemble the load-securement system.

In other embodiments, the anchor members include elements that enable the anchor members to attach to the attachment members of the shipping container in a manner other than threading the anchor members through the attachment members. In some embodiments, the anchor members include one or more carabiners, hooks, A-clips, or E-clips that enable the anchor members to be attached to the attachment members. For instance, for a given anchor member, a first carabiner is attached to one end and a second carabiner is attached to the other end. The first and second carabiners are attachable to attachment members of the shipping container to attach the anchor member to the shipping container. In some of these embodiments, the anchor members are reusable, as in certain instances they need not be cut to disassemble the load-securement system.

In certain embodiments, the load-securement system includes suitable netting attachable to the anchor members instead of or addition to the load restrainers.

In various embodiments, only one side of the vertical strap loop is threaded through the loop portions of the load restrainer rather than both sides as shown in FIGS. 5-11.

Various modifications to the above-described embodiments will be apparent to those skilled in the art. These modifications can be made without departing from the spirit and scope of this present subject matter and without diminishing its intended advantages. Not all of the depicted components described in this disclosure may be required, and some implementations may include additional, different, or fewer components as compared to those described herein. Variations in the arrangement and type of the components; the shapes, sizes, and materials of the components; and the manners of attachment and connections of the components may be made without departing from the spirit or scope of the claims set forth herein. Also, unless otherwise indicated, any directions referred to herein reflect the orientations of the components shown in the corresponding drawings and do not limit the scope of the present disclosure. This specification is intended to be taken as a whole and interpreted in accordance with the principles of the invention as taught herein and understood by one of ordinary skill in the art.

The invention is claimed as follows:

1. A load-securement apparatus comprising:
a first non-rigid anchor member;
a second non-rigid anchor member;
a first non-rigid load restrainer slidably attachable to the first non-rigid anchor member; and
a second non-rigid load restrainer attachable to the first non-rigid load restrainer and slidably attachable to the second non-rigid anchor member.

2. The load-securement apparatus of claim 1, wherein the first non-rigid load restrainer comprises a first non-rigid load-restraining member comprising a first loop.

3. The load-securement apparatus of claim 2, wherein the first loop is sized to receive the first non-rigid anchor member.

4. The load-securement apparatus of claim 3, wherein the first non-rigid load-restraining member further comprises a non-rigid barrier to which the first non-rigid load-restraining member is attached.

5. The load-securement apparatus of claim 4, wherein the non-rigid barrier comprises a first surface and an opposing second surface, and wherein the first non-rigid load-restraining member further comprises a first portion attached to the non-rigid barrier and extending along the first surface a second portion attached to the non-rigid barrier and extending along the second surface.

6. The load-securement apparatus of claim 5, wherein the first non-rigid load restrainer further comprises stitching that attaches the first and second portions of the first non-rigid load-restraining member to the non-rigid barrier.

7. The load-securement apparatus of claim 5, wherein the non-rigid barrier defines multiple openings therethrough, and wherein the first non-rigid load-restraining member is attached to the non-rigid barrier such that a portion of the first non-rigid load-restraining member passes through the openings in a serpentine manner.

8. The load-securement apparatus of claim 7, wherein the first load restrainer further comprises reinforcing stitching adjacent one of the openings.

9. The load-securement apparatus of claim 7, wherein the first non-rigid load restrainer further comprises a second non-rigid load-restraining member comprising a second loop sized to receive the second non-rigid anchor member.

10. A load-securement apparatus comprising:
a first anchor strap;
a second anchor strap;
a first load restrainer comprising:
(1) a first non-rigid barrier comprising a first surface and an opposing second surface and defining multiple openings;
(2) a first load-restraining strap comprising a first portion attached to the first non-rigid barrier and extending along the first surface of the first non-rigid barrier, a second portion attached to the first non-rigid barrier and extending along the second surface of the first non-rigid barrier, a loop portion between the first and second portions, and a free portion extending from the second portion and through two of the openings; and
(3) a second load-restraining strap comprising a first portion attached to the first non-rigid barrier and extending along the first surface of the first non-rigid barrier, a second portion attached to the first non-rigid barrier and extending along the second surface of the first non-rigid barrier, a loop portion between the first and second portions, and a free portion extending from the second portion and through two of the openings;
wherein the loop portions of the first and second load-restraining straps of the first load restrainer are sized to receive the first anchor strap to slidably attach the first load restrainer to the first anchor strap, and a second load restrainer comprising:
(1) a second non-rigid barrier comprising a first surface and an opposing second surface and defining multiple openings;
(2) a first load-restraining strap comprising a first portion attached to the second non-rigid barrier and extending along the first surface of the second non-rigid barrier, a second portion attached to the second non-rigid barrier and extending along the second surface of the second non-rigid barrier, a loop portion between the first and second portions, and a free portion extending from the second portion and through two of the openings; and
(3) a second load-restraining strap comprising a first portion attached to the second non-rigid barrier and extending along the first surface of the second non-rigid barrier, a second portion attached to the second non-rigid barrier and extending along the second surface of the second non-rigid barrier, a loop portion between the first and second portions, and a free portion extending from the second portion and through two of the openings; and
wherein the loop portions of the first and second load-restraining straps of the second load restrainer are sized to receive the second anchor strap to slidably attach the second load restrainer to the second anchor strap,
wherein the first load-restraining strap of the first load restrainer is attachable to the second load-restraining strap of the second load restrainer and the second load-restraining strap of the first load restrainer is attachable to the first load-restraining strap of the second load restrainer to attach the first and second load restrainers.

11. The load-securement apparatus of claim 10, further comprising a first load-restrainer connector configured to attach the first load-restraining strap of the first load restrainer to the second load-restraining strap of the second load restrainer and a second load-restrainer connector configured to attach the second load-restraining strap of the first load restrainer to the first load-restraining strap of the second load restrainer.

12. The load-securement apparatus of claim 11, further comprising a first anchor strap connector configured to attach two portions of the first anchor strap to form a loop and a second anchor strap connector configured to attach two portions of the second anchor strap to form a loop.

13. The load-securement apparatus of claim 10, wherein the first load restrainer further comprises first stitching that attaches the first and second portions of the first non-rigid load-restraining member of the first load restrainer to the first non-rigid barrier and second stitching that attaches the first and second portions of the second non-rigid load-restraining member of the first load restrainer to the first non-rigid barrier.

14. The load-securement apparatus of claim 13, wherein the first stitching includes longitudinal stitching and transverse stitching and the second stitching includes longitudinal stitching and transverse stitching.

15. The load-securement apparatus of claim 13, wherein the second load restrainer further comprises first stitching that attaches the first and second portions of the first non-rigid load-restraining member of the second load restrainer to the second non-rigid barrier and second stitching that attaches the first and second portions of the second non-rigid load-restraining member of the second load restrainer to the second non-rigid barrier.

16. The load-securement apparatus of claim 10, wherein the first load restrainer further comprises reinforcing stitching adjacent each of the openings.

17. The load-securement apparatus of claim 16, wherein the openings are linear and the reinforcing stitching extends transverse to the openings.

18. A load restrainer for a load-securement apparatus, the load restrainer comprising:
a non-rigid barrier comprising a first surface and an opposing second surface and defining multiple openings;
a first load-restraining strap comprising a first portion attached to the non-rigid barrier and extending along the first surface, a second portion attached to the non-rigid barrier and extending along the second surface, a loop portion between the first and second portions, and a free portion extending from the second portion and through two of the openings; and
a second load-restraining strap comprising a first portion attached to the non-rigid barrier and extending along the first surface, a second portion attached to the non-rigid barrier and extending along the second surface, a loop portion between the first and second portions, and a free portion extending from the second portion and through two of the openings.

19. The load restrainer of claim 18, further comprising first stitching that attaches the first and second portions of the first non-rigid load-restraining member to the non-rigid barrier and second stitching that attaches the first and second portions of the second non-rigid load-restraining member to the non-rigid barrier.

20. The load restrainer of claim 18, further comprising reinforcing stitching adjacent one of the openings.
